(19) United States
(12) Patent Application Publication
(10) Pub. No.: US 2012/0280653 A1
(43) Pub. Date: Nov. 8, 2012

(54) Electric Vehicle Fleet Management Charging Station Systems and Methods

(75) Inventors: Ronald D. Prosser, Huntington Beach, CA (US); Carl J. Allendorph, Pasadena, CA (US)

(73) Assignee: Green Charge Networks, Huntington Beach, CA (US)

(21) Appl. No.: 13/100,152

(22) Filed: May 3, 2011

(51) Int. Cl. H02J 7/04; H02J 7/00

(52) U.S. Cl. 320/109; 320/162

(57) ABSTRACT

Charging stations, systems for charging and identifying electric vehicles, and methods for detecting and providing charging information of a vehicle are provided. The charging stations include vehicle detectors, charging connectors, and system controllers to estimate the state of charge of a vehicle based on current measurements from the charging connectors and then to output charge status signals if the state of charge is at or above a predetermined energy level and the vehicle is detected as being properly positioned by the vehicle detectors. These results may be output to indicators, computers, and network connections. Also disclosed are systems where the vehicle has a vehicle information device readable by the vehicle detector to obtain vehicle data that is transmitted to the system controller and other components of the system. Methods of monitoring current, estimating state of charge, and providing a charge status signal if certain conditions are also present.

### CROSS-REFERENCE TO RELATED APPLICATIONS

Not applicable.

### STATEMENT REGARDING FEDERALLY SPONSORED RESEARCH

Not applicable.

### THE NAMES OF THE PARTIES TO A JOINT RESEARCH AGREEMENT

Not applicable.

### BACKGROUND

1. The Field of the Invention

The present invention generally relates to the field of apparatus, systems, and methods for designing and using charging stations for electric vehicles, and more particularly to the field of apparatus, systems, and methods for detection and indication of vehicle charging information at a charging station.

2. Description of Related Art

The advancement of battery technology and its application in the field of electrically-powered vehicles has given rise to potential for electric automobiles, motorbikes, public transit vehicles, and more. Battery-powered vehicles, plug-in hybrid electric vehicles, and other vehicles propelled by electrical energy stored in onboard electrical storage devices are just some examples of these electric vehicles (EVs) being deployed in the automotive marketplace. EVs are becoming more and more prevalent as environmental considerations, prices, and operating distances between recharges become more favorable over time, but the limited number of available vehicle charging locations and the typically lengthy time required for recharging the vehicle's batteries (when compared to refueling an internal combustion powered vehicle) are considerable barriers to widespread adoption.

As rental car agencies acquire fleets of EVs and the fleet sizes increase, these limitations are intensified. As the number of EVs managed gets larger, the likelihood that multiple EVs need to be charged at any given time increases as well, and more time needs to be spent charging the EVs. To counteract the development of these problems, EV charging stations are installed at rental car lots to charge waiting EVs, but because it is not economically or electrically feasible for the rental agency to provide fast EV charging stations to simultaneously charge each and every EV at a lot as the number of EVs goes up, the EVs are often queued up for available EV chargers, charged, and then rotated away so that other EVs can be charged in turn. Management of these EV fleets becomes even more difficult due to the fact that each EV model or EV brand has potentially different storage capacity, connectors, charging voltages, charging rates, and other physical and electrical characteristics. For example, even though multiple car manufacturers provide battery charging monitoring services, the services do not directly link to generic chargers, and a fleet manager using EVs from multiple manufacturers may have to aggregate multiple networks of EV charge information to observe charging conditions across his or her fleet. And even if that information can be managed, he or she may not to be able to conclusively pinpoint the location of a particular EV in the lot because onboard GPS systems are not typically precise enough to locate the parking stall in which a vehicle is being charged.

The subject matter claimed herein is not limited to embodiments that solve these described disadvantages or that operate only in environments or using measurables such as those described above. Rather, this background is only provided to illustrate one exemplary technology area where some embodiments described herein may be beneficially utilized.

### BRIEF SUMMARY

In accordance with one embodiment of the present invention, a charging system for a vehicle is provided. The charging system is comprised of a charging connector for charging a vehicle, the charging connector being operatively connected to a power source, at least one vehicle detector for detecting whether the vehicle is properly positioned, the vehicle detector being enabled to output detection signals, and a system controller associated with the charging connector and the vehicle detector. The system controller is enabled to measure current provided to the vehicle by a charging connector, determine a state of charge estimate of the vehicle based on the current measured, receive the detection signals from the vehicle detector, and output an output signal, wherein the output signal comprises a charge status signal from the charging station when the detection signals indicate that a vehicle is properly positioned, the current passing through the charging connector is less than or equal to a stop threshold current value, and the state of charge estimate is greater than or equal to a predetermined energy level.

In some embodiments of the invention, the vehicle has a vehicle information device that stores vehicle data, and the charging system further comprises a vehicle data reader configured to read and output the vehicle data from the vehicle information device. In some embodiments the vehicle data reader is the vehicle detector, and in some of those embodiments the system controller is enabled to receive vehicle data from the vehicle detector, and the output signal of the system controller is further comprised of a vehicle data signal containing the vehicle data when the system controller receives the vehicle data from the vehicle detector.

In some embodiments, the vehicle data reader is the system controller, and the output signal of the system controller is further comprised of a vehicle data signal containing the vehicle data when the system controller receives vehicle data from the vehicle information device.

In some embodiments, the vehicle information device is selected from a group consisting of an RFID tag, a two-way wireless communication device having an associated memory, a barcode, a QR code, and combinations thereof, and the vehicle detector is correspondingly enabled to receive the vehicle data from the vehicle information device.

In some embodiments the charging system the output signal of the system controller is further comprised of an alternate status signal when the detection signals indicate that the vehicle is not properly positioned, the state of charge estimate is not greater than or equal to the predetermined energy level, or the current passing through the charging connector is not less than or equal to the stop threshold current value.

In some embodiments, the system controller of the charging system estimates the state of charge of the vehicle by a method selected from the group consisting of a time-domain current hysteresis method and a time-domain energy thresholding method.

In some embodiments, the system is further comprised of an indicator, wherein the output signal of the system controller, the current measurement, or the detection signals are provided to the indicator.

In some embodiments, the system is further comprised of a computer connected to the system controller via a network connection, wherein the output signal of the system controller, the current measurement, or the detection signals are provided to the computer via a network connection.

In some embodiments, the system is further comprised of a data storage, wherein the output signal of the system controller, the current measurement, or the detection signals are provided to the data storage.

In other embodiments, a method for detecting and providing charging information of a vehicle is provided. The method comprises detecting whether a vehicle is properly positioned at a charging station, connecting a charging connector to the vehicle, the charging connector being operatively connected to a power source, charging the vehicle via a charging connector, monitoring current passing through the charging connector, estimating the state of charge of the vehicle, and providing an output signal comprising a charge status signal for the vehicle when the detection signals indicate that a vehicle is properly positioned, the current passing through the charging connector is less than or equal to a stop threshold current value, and the state of charge estimate is greater than or equal to a predetermined energy level.

In some embodiments, the method further comprises a step of indicating the output signal with a structure selected from the group consisting of an indicator, a computer, a network connection, and a data storage.

In some embodiments, the method further comprises the steps of reading vehicle data from a vehicle information device on the vehicle, and providing the vehicle data to a computer, a network connection, a data storage, or an indicator.

In some embodiments, the state of charge is estimated in the method by a method selected from the group consisting of a time-domain current hysteresis method and a time-domain energy thresholding method.

In some embodiments, the output signal of the method further comprises an alternate status signal that indicates that charging is incomplete until the state of charge indicates that charging is complete.

Embodiments of the invention make it possible to charge and track a large number of vehicles and provide indications of whether those vehicles are finished charging or not. When applied to the field of EV fleet management, the embodiments of the invention are especially useful because they allow charging and charge status indication of any number of dissimilar vehicles using a single type of charging station, due to the manner in which the state of charge of the vehicles is estimated and the relatively universal nature of the vehicle detectors. Therefore, a rental car agency implementing an EV fleet could install the charging stations assured that as future EVs and charging standards are introduced, their charging and detection infrastructure will need fewer adaptations and upgrades than other, more proprietary individual-vehicle-tailored charging stations.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE SEVERAL VIEWS OF THE DRAWINGS

In addition to the novel features and advantages mentioned above, other objects and advantages of the present invention will be readily apparent from the following descriptions of the drawings and exemplary embodiments, wherein like reference numerals across the several views refer to identical or equivalent features. It is appreciated that these drawings depict only typical embodiments of the invention and are therefore not to be considered limiting of its scope.

FIG. 1 is a block diagram of a vehicle and charging system according to an embodiment of the present invention.

FIG. 2 is a graph of current measured by a system controller over time according to an embodiment of the present invention.

FIG. 3 is a graph of energy transferred over time as determined by a system controller according to an embodiment of the present invention.

FIG. 4 is a graph of state of charge over time as determined by a system controller according to an embodiment of the present invention.

FIG. 5 is a block diagram of elements and signals of another embodiment of the present invention.

FIG. 6 is a flowchart depicting a method for detecting and providing charging information of a vehicle according to an embodiment of the present invention.

### DETAILED DESCRIPTION

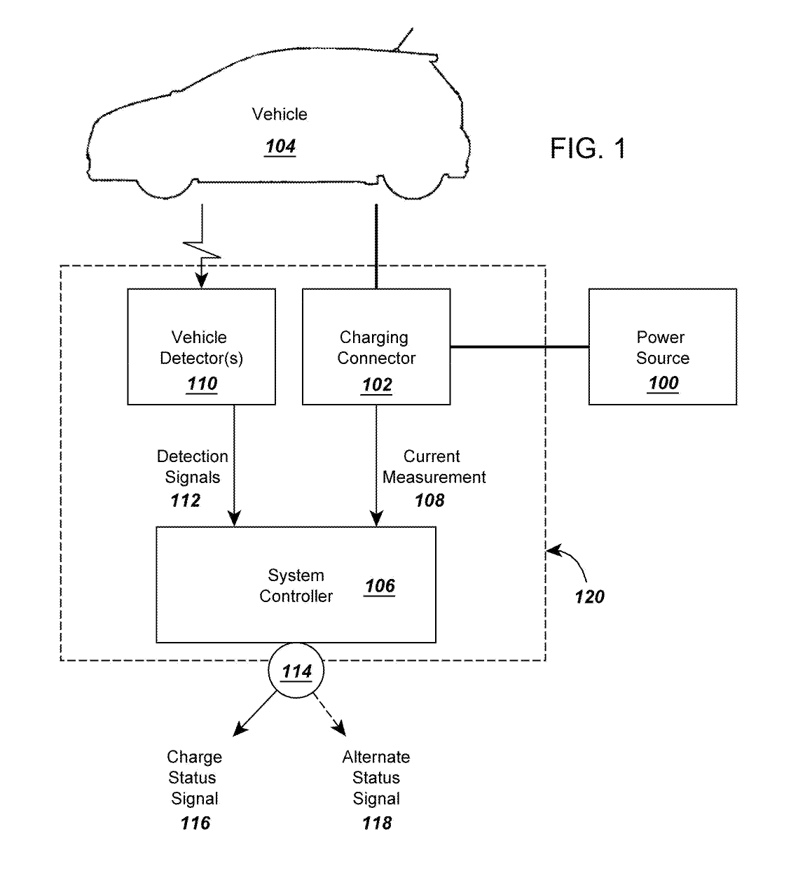

Referring now to the drawings, FIG. 1 is a block diagram of a vehicle and charging system according to an embodiment of the present invention. As shown in this embodiment, a power source 100 provides power to a charging connector 102 to charge a vehicle 104. A system controller 106 measures the electrical current 108 passing through the charging connector 102, and a vehicle detector or plurality of vehicle detectors 110 provides detection signals 112 to the system controller 106. The system controller 106 has at least one output connection 114 through which a charge status signal 116 or alternate status signal 118 are output after the system controller 106 determines the proper signal to transmit. In this embodiment, the charging station 120 includes the charging connector 102, vehicle detector(s) 110 and the system controller 106.

Power source 100 represents the source of electrical power provided to the charging connector 102. For example, in some embodiments, an electrical utility distribution grid, solar/photovoltaic panel, electrical generator, electrical battery storage unit, or other similar source of electrical power may be an adequate power source 100 as long as it provides the current needed to charge the vehicle 104. Although the power source 100 is depicted external to the charging station 120 in FIG. 1, the power source 100 may be internal to the charging station 120. Internal power sources could include, for example, a battery, a gas generator, or a solar panel, and external power sources could include, for example, a connection to a utility distribution grid or remotely positioned power plant.

The charging connector 102 is a means by which electrical energy is transferred to the vehicle 104. In some embodiments, the charging connector 102 is one of the standardized CHAdeMO and SAE J1772 connectors with wired electrical plugs that connect to a charging port on the vehicle 104 for charging onboard vehicle batteries. The charging connector 102 may also be any other connector type, provided that a current measurement 108 can be reliably taken at some point that reflects the current passing into the vehicle 104 and the current measurement 108 will drop and/or approach a predetermined electrical stop threshold current value as the vehicle 104 is fully recharged.

The vehicle 104 is a means of transportation, such as, for example, an electric vehicle (EV), battery electric vehicle (BEV), hybrid electric vehicle (HEV), and plug-in hybrid electric vehicle (PHEV), including an electric car, truck, train, cycle, aircraft, spacecraft, watercraft, or other like vehicle. The physical characteristics of the vehicle 104 have correlating features with the charging connector 102 and the vehicle detectors 110. For example, in some embodiments the vehicle 104 has a battery that can be charged by the charging connector 102 as long as the vehicle has a corresponding charging port and has the physical characteristics required for the vehicle detectors 110 to sense its presence and/or positioning. Such physical characteristics may include having a large mass of metal for detection by metal detectors.

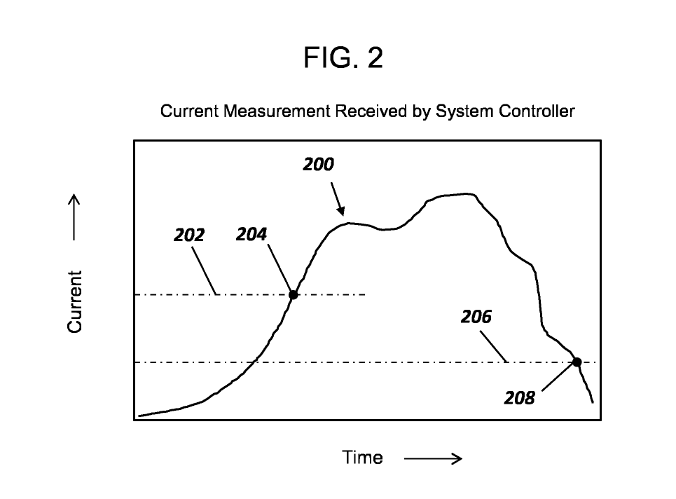

The system controller 106 is an assembly of components that receive, process, and output data. Those of ordinary skill in the art will appreciate that these functions can be fulfilled on a computer, by software, hardware, or firmware implemented by a computing device, and other like structures. In one embodiment, for example, the system controller 106 is a computer associated with an analog/digital (A/D) conversion unit for receiving and converting analog current measurements 108 into digital signals readable by the computer, and in other embodiments the computer is capable of receiving analog signals. The computer may also be associated with a vehicle detector transducer that receives and interprets the detection signals 112 for the computer. A data acquisition card installed in the computer may also fill the role of the A/D conversion unit or vehicle detector transducer if the signals (108 and 112) coming from the sensors (102 and 110) are properly configured to so communicate. The computer of the system controller 106 of this embodiment reads these input signals and estimates the state of charge of the vehicle 104 as described below in association with FIGS. 2, 3, and 4. Other embodiments employ other methods commonly known in the state of the art for estimating the state of charge of the vehicle based on the current passing into the vehicle through the charging connector. In some embodiments, if the state of charge of the vehicle meets or exceeds a predetermined energy level, the system controller 106 outputs a charge status signal 116 via its output connection 114. In some embodiments, the system controller 106 may also output an alternate status signal 118 if the state of charge of the vehicle 104 does not meet or exceed the predetermined energy level or if other data (such as, for example, an estimate of the state of charge of the vehicle) is desired as a separate output from the charge status signal 116.

The current measurement 108 is a measurement of the electrical current passing into the vehicle 104. FIG. 1 shows an embodiment in which the current measurement 108 is taken from the charging connector 102, but the current measurement 108 may be measured from cords leading to the charging connector, electrical connections at the power source, or other intervening points as long as the current measurement 108 sent to the system controller 106 accurately reflects the current that is presently passing into the vehicle 104. In some embodiments the current measurement 108 is taken using a current transformer, Hall-effect current sensor transducer, ammeter, shunt resistor, magneto-resistive field sensor, or similar means for measuring current positioned at or near the charging connector 102.

The vehicle detector or vehicle detectors 110 are sensors configured to determine the presence and position of the vehicle 104 and to transmit detection signals 112 to the system controller 106. The vehicle detectors 110 of the embodiment of FIG. 1 are passive detectors, meaning the vehicle 104 does not actively or electronically transmit data to the detectors 110 to alert the detectors 110 of the presence or properties of the vehicle 104. (Therefore, a jagged arrow connects the vehicle 104 and the vehicle detectors 110.) Rather, the vehicle detectors 110 in this embodiment passively detect the weight, size, shape, chemical makeup, and/or other physical properties of the vehicle 104 and send these signals 112 to the system controller 106. For example, a vehicle detector 110 in one embodiment is a pressure transducer or load cell positioned at a point where a vehicle 104 will be parked while charging. The pressure transducer sends a weight signal to the system controller 106 as a detection signal 112. A passive inductive device may also be used to detect the large mass of metal of the vehicle 104 when it is positioned at the vehicle detectors 110. A motion sensor, magnetically actuated device, camera, or optical detector could serve as a vehicle detector 110 as well. In the case of motion sensors, the vehicle detectors 110 detect nearby motion as the vehicle approaches the charging station 120 or the charging connector 102 is connected to the vehicle 104. Magnetically actuated vehicle detectors 110 could be triggered by the metal portions of the vehicle 104 or the charging connector 102 when they move into position. An optical detector or camera-based vehicle detector 110 would collect optical, infrared, or other comparable electromagnetic information near the charging station 120, and would preferably utilize pattern-recognition software or other methods to determine whether a vehicle 104 is present at the station 120.

The vehicle detectors 110 can consist of a plurality of sensors or just one, insofar as the detector or detectors 110 can not only detect the presence of the vehicle 104, but can also detect information sufficient to determine whether the vehicle 104 is properly positioned at the charging station 120. For example, if load cell sensors are used, then two to four load cells positioned under pads on which the vehicle's wheels will remain while charging will serve this function because the load cells would not only sense the weight of an object (e.g., the vehicle) on the pads, but would also be able to provide data concerning whether the wheels are in the correct location for charging. This requirement helps to avoid false positive determinations for a vehicle's positioning such as when a vehicle is only halfway in position or just in a nearby location. In some embodiments an ultrasonic proximity sensor is used, and in those embodiments, the ultrasonic sensor must provide distance information to serve as a vehicle detector 110 so that it can be determined whether or not the vehicle 104 is within charging distance of the charging connector 102 or within some other predetermined distance from the ultrasonic vehicle detector.

Detection signals 112 are the signals coming from the vehicle detectors 110 to the system controller 106. As mentioned above, these signals 112 provide information to the system controller to determine the presence and propriety of positioning of the vehicle 104 at the charging station 120.

The output connection 114 of the system controller 106 is a point at which a signal can be sent to or accessed by another system of components, such as, for example, an electrical or network port, or a wireless communication interface, on a computer that is part of the system controller 106. In some embodiments, the system controller 106 has multiple output connections 114 to output multiple signals simultaneously or to send the same signal to multiple destinations, and in other embodiments, one output connection 114 is used to transmit multiple different signals.

The charge status signal 116 is a signal provided by the system controller 106 through the output connection 114. In some embodiments, the signal 116 is an electrical indication that the charging of the vehicle 104 by the charging connector 102 is complete or that the charging connector 102 may be safely disconnected from the vehicle 104. In other embodiments, the charge status signal is an output of this information along with a simultaneous parallel or pass-through transmission of the current measurement 108, detection signals 112 received by the system controller 106, and/or an estimate of the state of charge of the vehicle 104 determined by the system controller 106.

The alternate status signal 118 is an additional feature of some embodiments of the invention. In some embodiments, the alternate status signal 118 merely bears information indicating that the charging of the vehicle 104 is not yet complete. In other embodiments, current measurements 108, detection signals 112, and estimates of the state of charge are sent as an alternate status signal 118 aside from the charging status of the vehicle. In other embodiments, the alternate status signal 118 comprises a signal indicating “charge incomplete” or a like message, allowing the charging station to indicate that charging is not finished similar to how the charging station indicates that charging is finished.

FIG. 2 is a graph of the current measurement 108 received by the system controller 106 over time according to an embodiment of the present invention. As shown, a current measurement curve 200 rises and falls over one recharge cycle of a vehicle from a depleted state to a charged state. The current measurement curve 200 passes a start threshold current value 202 at a point 204 and falls below a stop threshold current value 206 at another point 208. The system controller 106 uses this data in some embodiments to estimate the state of charge of the vehicle 104 via a time-domain hysteresis method. According to this method, current is measured while it passes into the vehicle. When the current has reached the start threshold current value 202, the controller 106 registers the time corresponding to this point 204 as the start of charging. The controller 106 continues to monitor the current and watches for a second, lower stop threshold current value 206. When current consumption reaches this point 208, the controller 106 registers that the vehicle has ceased charging and, therefore, that the state of charge of the vehicle is at or near full (100%).

The time-domain hysteresis method of determining state of charge has some complications, however. On very warm days or when the vehicle 104 has had a heavy usage pattern, temperature of the batteries in the vehicle 104 may be elevated. When this happens, the vehicle 104 cannot charge at as high a charge rate in order to avoid thermal runaway or damage to the batteries. As such, care must be taken in selecting the hysteresis between the start threshold current value 202 and the stop threshold current value 206 to avoid these conditions while still reliably estimating state of charge.

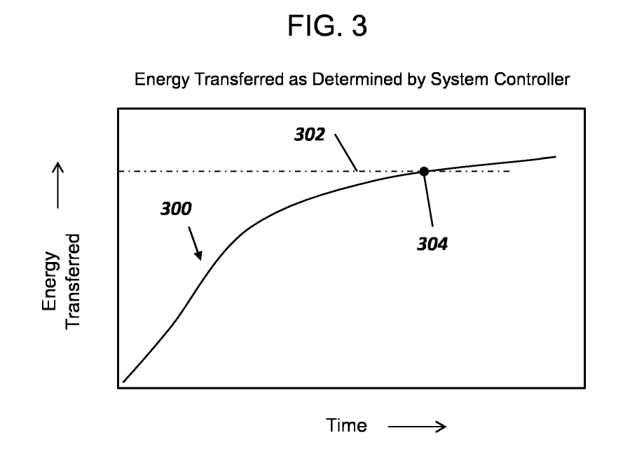

FIG. 3 is a graph of energy transferred over time as determined by the system controller according to yet another embodiment of the present invention. An energy transfer curve 300 shows the amount of energy transferred to a vehicle via the charging connector 102 over time, and it passes a stop threshold energy value 302 at a point 304. This information is used in an alternative method of estimating the state of charge of the vehicle, wherein the state of charge of the vehicle is determined using a method of integration of the time-domain current curve to calculate the total energy delivered to the vehicle (e.g., in kilowatt-hours). The points of the energy transfer curve 300 are generated as the current measurement curve 200 is integrated over time, and once the curve 300 surpasses the stop threshold energy value 302 at some point 304, the state of charge of the vehicle 104 is deemed to be “practically full,” and the system controller registers that charging is complete, regardless of the present value of the current measurement 108, provided that the detection signals 112 still show that a vehicle 104 is present and properly positioned for charging at the station. However, if the current measurement 108 falls below the stop threshold current value 208 at any time during charging as the energy transfer is being monitored, the system controller 106 sends a charge status signal 116 indicating the conclusion of charging, because it is assumed that when the current measurement 108 falls below the stop threshold current value 208 that the state of charge is “practically full,” if not exactly 100%, even if the stop threshold energy value 302 has not yet been reached.

This state of charge estimation technique is preferably implemented when the vehicle 104 has a known total energy storage capacity or that whatever vehicle is charged by the charging station has a total energy storage capacity below an upper limit. This information is beneficial because when the energy transfer curve 300 surpasses the stop threshold energy value 302, the vehicle may be assumed to be “practically full” or “charged enough” for the user's purposes. Because the actual state of charge of the vehicle and the actual energy storage capacity of the vehicle may be unknown to the controller at the time charging initiates, the controller can simply determine whether or not the vehicle has received a charge greater than or equal to some total number of kWh and finish charging at that point.

If the total energy storage capacity of the vehicle is unknown, the stop threshold energy value 302 is arbitrary because it is unclear whether a given amount of energy transfer will be considered “enough” for that particular vehicle. Nevertheless, it is contemplated that in some embodiments the user may practice the invention without knowledge of the total energy storage capacity of the vehicle as long as an arbitrary energy value for the stop threshold energy value 302 is acceptable to him or her. For example, a user may wish to simply transfer 10 kWh of energy to every EV charged, regardless of the EV's actual capacity, and this would fall within the scope of the invention.

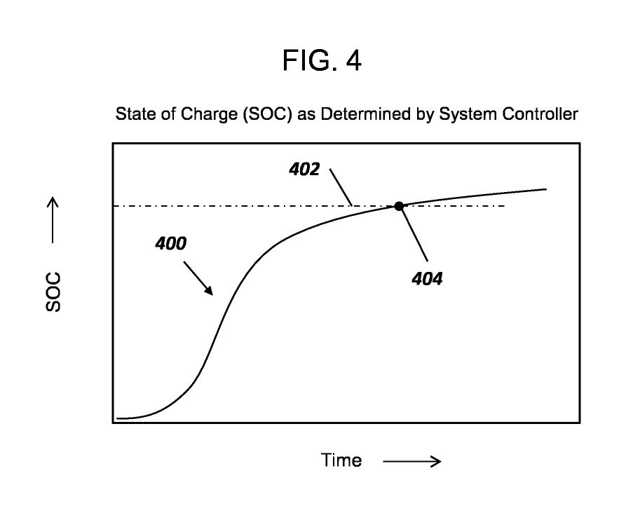

FIG. 4 is a graph of state of charge over time as determined by the system controller according to an embodiment of the present invention. A state of charge curve 400 shows the state of charge (SOC) of the vehicle as estimated or calculated by the system controller over a recharging cycle from very low SOC to a very high SOC. As the vehicle charges, the SOC passes a predetermined energy level 402 at a point 404 near the time that it has maximum SOC. The system controller 106 generates and monitors the state of charge curve 400, and when the state of charge reaches the predetermined energy level 402, the vehicle 104 is deemed “practically full” or “charged enough,” as mentioned above. At this point 404, the charge status signal 116 is sent from the output connection 114 by the system controller 106.

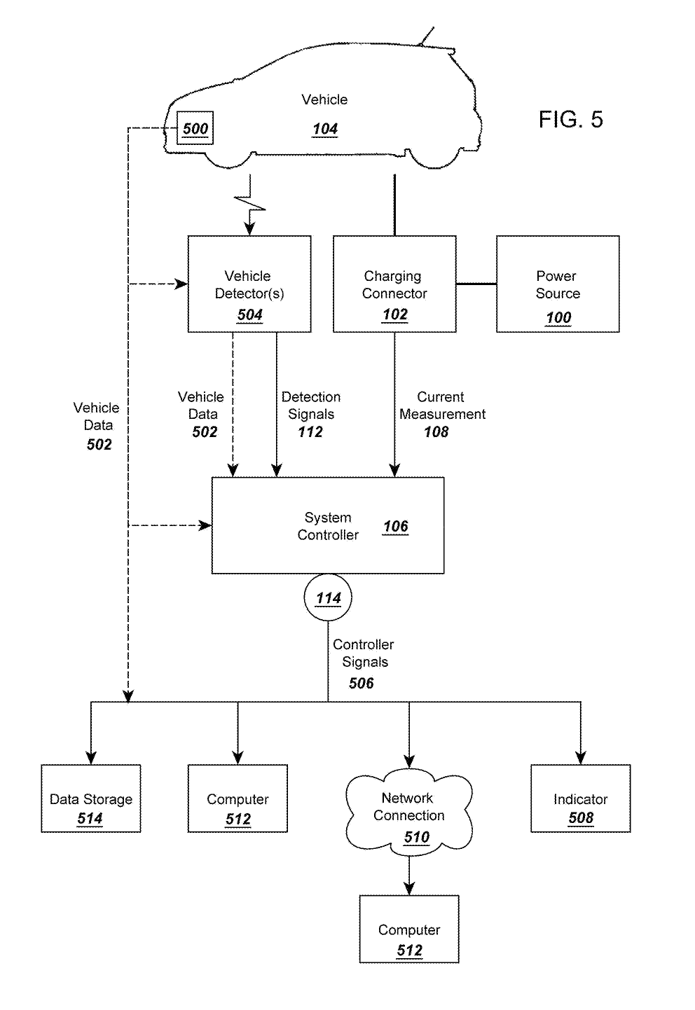

FIG. 5 is a block diagram of elements and signals of yet another embodiment of the present invention. A power source 100 provides power to a charging connector 102 that is connected to a vehicle 104 to provide charging. While the vehicle 104 is charging, the system controller 106 takes current measurements 108 from the charging connector 102 to calculate an estimate of the state of charge of the vehicle. A vehicle detector (or detectors) 504 detect the presence of a vehicle 104 and transmit that information as detection signals 112. Onboard the vehicle 104 is a vehicle information device (or plurality of vehicle information devices) 500 that stores vehicle data 502 which is readable by vehicle detectors 504. This vehicle data 502 is provided to the system controller 106 along with the detection signals 112 from the vehicle detectors 504. The system controller 106 in this embodiment has an output connection 114 through which controller signals 506 and/or vehicle data 502 are sent to an indicator 508, network connection 510, computer 512, or data storage means 514 as certain conditions are met by the vehicle detectors 504 and the current measurement 108. The network connection 510 can be configured to link the output connection 114 to a computer 512.

In some embodiments, the vehicle information device (or devices) 500 are active or passive communication devices stored in or on the vehicle 104. The devices 500 serve as repositories of vehicle data 502 and are accessed by a vehicle detector or detectors 504. For example, the vehicle information device 500 may be a passive device such as an RFID tag, barcode, or QR barcode that holds vehicle data 502. These devices are passive because they are accessed and/or powered by external means to retrieve the vehicle data 502 stored within. A license plate is also a passive device that is suitable for this purpose if the vehicle detectors 504 have a camera or other optical detection means capable of reading or recording the information on the plate. In active devices, power is provided within the vehicle 104 to enable the vehicle information device 500 to transmit vehicle data 502 to the vehicle detectors 504. Some examples of active devices include wireless interrogation devices, active RFID tags, Bluetooth™ or ZigBee™ devices, a wireless Ethernet-connected computer, or infrared, radio, or other active electromagnetic transmission device.

Vehicle data 502 that is sent from the vehicle 104 to the charging station would in some embodiments include the vehicle's vehicle identification number (VIN), a license plate number, account number for charging an account for electricity usage, vehicle model name or number, vehicle total energy storage capacity, fleet unit number, or other identifying information. The vehicle data 502 may be accessed by the vehicle detectors 504 or by other components of the system such as, for example, the system controller 106, indicator 508, network connection 510, computer 512, or data storage 514, depending on the type of vehicle information device 500 used and the power of the transmission (or sensitivity of the reception) of the vehicle data 502 by these destination devices. The embodiment shown in FIG. 5 indicates with dashed lines that the vehicle data 502 is, in some embodiments, received by the vehicle detectors 504 and then passed to the system controller 106 or alternatively transferred directly to the system controller 106, indicator 508, network connection 510, computer 512, or data storage 514. Sending the vehicle data 502 along multiple of these routes is also performed in some embodiments of the invention.

The vehicle detectors 504 serve multiple functions in the embodiments typified by the embodiments of FIG. 5. First, the vehicle detectors 504 detect the presence and proper positioning of a vehicle 104 and relay that information as detection signals 112 to the system controller 106. This detection may take place in the manner described in connection with the vehicle detectors 110 of FIG. 1, with motion sensing, ultrasonic detection, pressure sensing, magnetic actuation, optical detection, etc. Second, the vehicle detectors 504 are enabled in some embodiments to receive vehicle data 502 and relay that information to the system controller 106 as well. In some embodiments, the detection signals 112 and the vehicle data 502 are the same data signal, and in other embodiments, the signals 112 and data 502 are provided to the system controller 106 separately. In some of the embodiments where the detection signals 112 and vehicle data 502 are the same signal, that signal can be used to both detect the vehicle 104 and transfer data about the vehicle 104. For example, if the vehicle information device 500 is an RFID tag and the vehicle detector 504 is an RFID reader, then if the tag and reader are properly calibrated, the RFID information (which in this case is the vehicle data 502) from the tag will only be read by the reader if the vehicle 104 is in a proper position, so the RFID information also serves as a detection signal 112. In other words, merely detecting a signal from the RFID vehicle information device 500 implies that the vehicle 104 is properly positioned, so separate detection signals 112 and vehicle data 502 would be unnecessary and redundant in this case.

A jagged line links the vehicle 104 to the vehicle detectors 504 to indicate that the vehicle detectors 504 in this figure can be passive devices as in FIG. 1. However, in other embodiments the vehicle data 502 received by the vehicle detectors may indicate the proper positioning of the vehicle 104 using an active transmission of that state, such as, for example, if the vehicle 104 has an internal switch that a user can toggle to actively transmit a signal indicating that “the vehicle is in position” or other similar signal to a nearby vehicle detector 504.

The controller signals 506 are signals that are output by the system controller 106, such as, for example, a charge status signal, alternate status signal, vehicle data signal, current measurement, detection signal, and state of charge estimate. The controller signals 506 in some embodiments are sent through the output connection 114 of the system controller 106 individually or simultaneously. For example, in some embodiments, the charge status signal and the vehicle data are output as controller signals 506 only when the vehicle 104 is completely charged. In other embodiments, the charge status signal is not output until charging of the vehicle 104 is finished, but the vehicle data is output constantly as a controller signal 506 without respect to state of charge of the vehicle 104. In these embodiments, for example, the computer 512 can detect the presence and type of vehicle present at the charging station when the vehicle 104 is still charging, and with this information the computer 512 can deduce that there is a vehicle charging in that location, but that the system controller 106 has not determined that the vehicle has completed charging. Alternatively, in some embodiments a charge status signal and vehicle data signal are output as controller signals 506 when the vehicle 104 is charging, but the charge incomplete signal and vehicle data signal are output when the system controller 106 determines that the vehicle 104 has not finished charging. In yet other embodiments, the controller signals 506 include the recent history of current measurements taken or other data gathered or generated by the system controller 106. Additional configurations of these signals are also contemplated, as will be apparent to one having ordinary skill in the art.

The indicator 508 in some embodiments is a lamp, light, display, computer monitor, television, screen, beacon, or other visual signal. These visual indicators 508 react to the controller signals 506 and/or vehicle data 502 by lighting up or turning off to show, for example, whether a charge status signal or no signal is being delivered to the indicator 508. Other indication methods known in the art are also proper to use as an indicator 508, such as, for example, a vibrating or moving object, a speaker emitting sound alerts, or an electronic signal. The indicator 508 may also be configured to indicate whether a vehicle 104 is properly positioned, charging, providing a current measurement 108, delivering vehicle data 502, or other similar system status information. In addition, the indicator 508 may be beneficially configured in some embodiments to emit multiple “on” states, colors, or sounds depending on the information received, or may be comprised of multiple lights or other indication means to show diverse or discrete information simultaneously.

In some embodiments, a network connection 510 is configured as a means for delivering the controller signals 506 and/or vehicle data 502 to a connected computer (or plurality of computers) 512. The network connection 510 is comprised of components necessary for transferring controller signals 506 and/or vehicle data 502 in this manner. In some embodiments this means that the network connection 510 includes a network adapter receiving the controller signals 506, a modem for transmission of the controller signals 506, and another modem and network adapter at the computer 512 to convert the signals sent into a computer-readable form. In accordance with network communication methods commonly known in the art, the scope of the network connection 510 is contemplated to encompass a wired or wireless local area network (LAN), wired or wireless wide area network (WAN), the Internet, a cellular or wireless broadband communications network (e.g., GSM, CDMA, LTE, WiMAX, etc.), radio frequency (RF) transmission network, and combinations thereof. A complex network connection 510 would be, for example, an RF transceiver that sends a controller signal 506 that is detected by a LAN that shares a GSM connection to another LAN on which a computer 512 is connected.

The computer 512 is a computing device configured to receive controller signals 506 and/or vehicle data 502. In some embodiments, the computer 512 has an associated memory for storing the controller signals 506 and/or vehicle data 502. In some embodiments, the computer 512 has an associated display for presenting the controller signals 506 and/or vehicle data 502 in a user-readable format. The computer in these embodiments comprises a processor, a memory, and optionally a data storage means. The processor is configured to at least be able to execute instructions stored in the memory and potentially retrieved from the data storage. Computer terminals, servers, mobile devices such as smartphones or laptop computers, computing tablets, and the like are examples of computers 512 in some embodiments.

In some embodiments, a data storage 514 is connected to the output connection 114 of the system controller 106 and is configured to receive controller signals 506 and/or vehicle data. The data storage 514 is a unit for recording and storing the controller signals 506 and/or vehicle data 502, such as, for example, a hard drive, disk, printer, or other permanent or semi-permanent long- or short-term storage device. In various embodiments the data storage 514 is placed internally or externally to a housing of the system controller 104, and is connected with components that enable the controller signals 506 and/or vehicle data 502 to be recorded by the data storage 514.

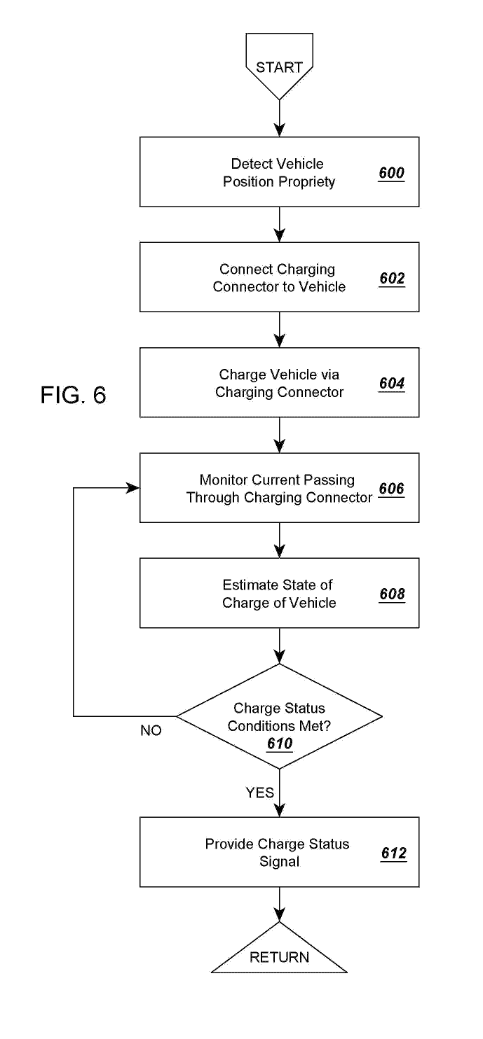

FIG. 6 is a flowchart depicting a method for detecting and providing charging information of a vehicle according to an embodiment of the present invention. In step 600, a vehicle is detected, and the propriety of its position at a charging station is determined. In step 602, a charging connector is connected to the vehicle in a manner suitable for charging the vehicle. In step 604, the vehicle is charged via the charging connector. For example, energy is transferred into the vehicle to recharge onboard batteries. In step 606, the current passing through the charging connector is monitored. For example, an associated system controller or computer may take current measurements from the charging connector to perform this step. In step 608, the state of charge of the vehicle is estimated, and if charge status conditions are met in step 610, a charge status signal is provided 612. If charge status conditions are not met in step 610, the next step is to loop back to step 606 where the current is monitored. Estimation of the state of charge of the vehicle in step 608 is performed using methods related to monitoring or measuring the current passing through the charging connector, such as, for example, a time-domain current hysteresis method or a time-domain energy thresholding method. The results of the state of charge estimation are used in step 610 in determining whether charge status conditions are met. For example, if the state of charge of the vehicle exceeds a predetermined energy level, the charge status signal is produced under step 612, indicating that charging is complete, and the method is restarted. In another alternative embodiment, if the state of charge indicates that charging is not complete, an alternate status signal is provided, and the alternate status signal indicates that charging is incomplete until the state of charge indicates that charging is complete, at which time the charge status signal indicates that charging is complete and the alternate status signal may turn off. The method may also include additional step of indicating the output signal with an indicator, a computer or computer display, a network connection (with an appropriate means for interpreting the signal for user interfacing and reading), and/or a data storage that is properly configured for user access. The method may also include additional steps of reading vehicle data from a vehicle information device on the vehicle and providing and/or storing the vehicle data to a computer, a network connection, a data storage unit, or an indicator.

It is to be understood that methodological instructions according to the present invention may be programmed into software executed by a general use computer, a special use computer, a special purpose processing device to perform a certain function or group of functions, or as firmware or other similar computer-readable instructions executed by these computing and processing devices. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, Compact Disc (CD), DVD, Blu-ray Disc (BD) or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A charging system for a vehicle comprising:
(a) a charging connector for charging the vehicle, the charging connector being operatively connected to a power source;
(b) at least one vehicle detector for detecting whether the vehicle is properly positioned, the vehicle detector being enabled to output detection signals; and
(c) a system controller associated with the charging connector and the vehicle detector, the system controller being enabled to:
(i) measure current provided to the vehicle by the charging connector,
(ii) determine a state of charge estimate of the vehicle based on the current measured,
(iii) receive the detection signals from the vehicle detector, and
(iv) provide an output signal, wherein the output signal is comprised of a charge status signal from the charging station when the detection signals indicate that a vehicle is properly positioned, the current passing through the charging connector is less than or equal to a stop threshold current value, and the state of charge estimate is greater than or equal to a predetermined energy level.

2. The charging system of claim 1 wherein the vehicle has a vehicle information device, the vehicle information device storing vehicle data; and further comprising a vehicle data reader configured to read and output the vehicle data from the vehicle information device.

3. The charging system of claim 2 wherein the vehicle data reader is the vehicle detector.

4. The charging system of claim 3 wherein the system controller is further enabled to receive vehicle data from the vehicle detector, and the output signal of the system controller is further comprised of a vehicle data signal containing the vehicle data when the system controller receives the vehicle data from the vehicle detector.

5. The charging system of claim 2 wherein the vehicle data reader is the system controller, and wherein the output signal of the system controller is further comprised of a vehicle data signal containing the vehicle data when the system controller receives vehicle data from the vehicle information device.

6. The charging system of claim 2, wherein the vehicle information device is selected from a group consisting of an RFID tag, a two-way wireless communication device having an associated memory, a barcode, a QR code, and combinations thereof, and the vehicle detector is correspondingly enabled to receive the vehicle data from the vehicle information device.

7. The charging system of claim 1 wherein the output signal of the system controller is further comprised of an alternate status signal when the detection signals indicate that the vehicle is not properly positioned, the state of charge estimate is not greater than or equal to the predetermined energy level, or the current passing through the charging connector is not less than or equal to the stop threshold current value.

8. The charging system of claim 1 wherein the system controller estimates the state of charge of the vehicle by a method selected from the group consisting of a time-domain current hysteresis method and a time-domain energy thresholding method.

9. The charging system of claim 1 further comprising an indicator, wherein the output signal of the system controller, the current measurement, or the detection signals are provided to the indicator.

10. The charging system of claim 1 further comprising a computer, wherein the output signal of the system controller, the current measurement, or the detection signals are provided to the computer.

11. The charging system of claim 1 further comprising a computer connected to the system controller via a network connection, wherein the output signal of the system controller, the current measurement, or the detection signals are provided to the computer via the network connection.

12. The charging system of claim 1 further comprising a data storage, wherein the output signal of the system controller, the current measurement, or the detection signals are provided to the data storage.

13. A method for detecting and providing charging information of a vehicle, the method comprising:
(a) detecting whether a vehicle is properly positioned at a charging station,
(b) connecting a charging connector to the vehicle, the charging connector being operatively connected to a power source,
(c) charging the vehicle via the charging connector,
(d) monitoring current passing through the charging connector,
(e) estimating the state of charge of the vehicle, and
(f) providing an output signal comprising a charge status signal for the vehicle when the detection signals indicate that a vehicle is properly positioned, the current passing through the charging connector is less than or equal to a stop threshold current value, and the state of charge estimate is greater than or equal to a predetermined energy level.

14. The method of claim 13 further comprising:
(g) indicating the output signal with a structure selected from the group consisting of an indicator, a computer, a network connection, and a data storage.

15. The method of claim 13 further comprising:
(g) reading vehicle data from a vehicle information device on the vehicle, and
(h) providing the vehicle data to a computer, a network connection, a data storage, or an indicator.

16. The method of claim 13 wherein the state of charge is estimated by a method selected from the group consisting of a time-domain current hysteresis method and a time-domain energy thresholding method.

17. The method of claim 13 wherein the output signal further comprises an alternate status signal that indicates that charging is incomplete until the state of charge indicates that charging is complete.
